(19) United States
(12) Patent Application Publication
(10) Pub. No.: US 2014/0345264 A1
(43) Pub. Date: Nov. 27, 2014

(54) BALL ROTARY ENGINE

(71) Applicant: Lauren J. Ball, Hallsville, TX (US)

(72) Inventor: Lauren J. Ball, Hallsville, TX (US)

(21) Appl. No.: 13/898,702

(22) Filed: May 21, 2013

(51) Int. Cl. F15B 1/033

(52) U.S. Cl. CPC F15B 1/033
USPC 60/409

(57) ABSTRACT

A rotary engine system powered by pressurized air where the system includes: a pressure chamber, where pressure chamber includes a furnace beneath the pressure chamber; a rotary engine, where the rotary engine receives pressurized air from the pressure chamber; a rotary compressor, where the rotary engine and rotary compressor share a drive shaft, the rotary compressor creates compressed air that is transmitted to the pressure chamber; a buffer chamber, where the buffer chamber receives the compressed air prior to transfer into the pressure chamber; and a control the control module, where module controls functions related to the rotary engine, pressure chamber and buffer chamber.

### BACKGROUND OF THE INVENTION

1. Field of Invention

A present invention relates to a rotary engine that uses air pressure as an energy source.

2. Description of Related Art

Internal combustion engines are common and are the most prevalent used engines in modern society. Internal combustible engines typically utilize hydrocarbon fuel as a energy source. It is well known hydrocarbon fuels are limited in nature and have some negative aspects associated with them. In particular the price of hydrocarbon fuels has been steadily increasing over the years and the environment is suffering due to the high usage of hydrocarbon fuels for transportation and energy generation. Consequently it would be advantageous to replace the hydrocarbon engine in order to avoid further environmental harm and high costs associated with hydrocarbon fuel.

### SUMMARY OF THE INVENTION

The present invention relates to a rotary engine system powered by pressurized air comprising: a pressure chamber, where pressure chamber includes a furnace beneath the pressure chamber; a rotary engine, where the rotary engine receives pressurized air from the pressure chamber; a rotary compressor, where the rotary engine and rotary compressor share a drive shaft, the rotary compressor creates compressed air that is transmitted to the pressure chamber; a buffer chamber, where the buffer chamber receives the compressed air prior to transfer into the pressure chamber; and a control the control module, where module controls functions related to the rotary engine, pressure chamber and buffer chamber.

### BRIEF DESCRIPTION OF DRAWINGS

FIG. 1 depicts a pressure chamber and furnace in accordance with the present invention.

FIG. 2 depicts a buffer chamber connected to the pressure chamber in accordance with the present invention.

FIG. 3 depicts a control module used in accordance with the present invention.

FIG. 4 depicts a ball rotary engine housing in accordance with the present invention.

FIG. 5 depicts a control assembly housing in accordance with the present invention.

FIG. 6 depicts a compressor and control assembly in accordance with the present invention.

### DETAILED DESCRIPTION

The present invention relates to an external heat computer-controlled pressure driven ball rotary engine. In particular, the present invention discloses a ball rotary engine that receives power from heated air pressure.

Atmospheric air is drawn through a filter, compressed by a compressor and expelled under pressure to a pressure-buffer chamber, which maintains a constant pressure controlled by a pressure relief valve and releases into a pressure expansion chamber. The pressure in the pressure expansion chamber remains equal to the pressure of the pressure buffer chamber, but the volume is expanded by a factor of ten by heat from a furnace. This expanded pressure volume is channeled to a rotor of the ball rotary engine through a manual control valve and a computer control valve and through a control assembly housing to a rotor vane and a reverse pressure flap valve forcing the engine to rotate. The ball rotary engine is composed of two or more rotors offset for perfect balance in different expansion chambers insuring that a constant, steady, expanding pressure is applied to the rotator vanes. When the rotor vanes reach 45 degrees from top center a pressure sensor sending pressure information to a control module compares data from the buffer pressure sensor sending an electrical current closing a solenoid valve shutting off the pressure to the pressure expansion chamber allowing for the expanding pressure to drive the rotor vanes to complete the cycle.

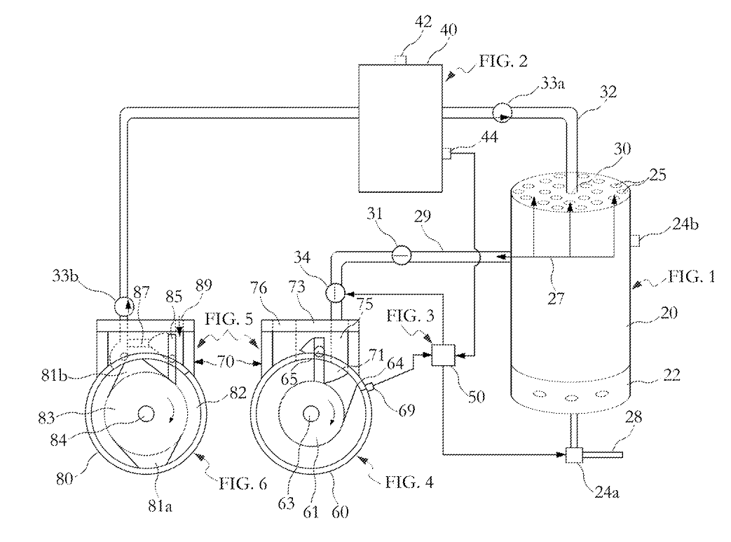

In reference to FIG. 1, a Pressure Chamber 20 in accordance with the present invention is depicted. The Pressure Chamber 20 includes a furnace 22 just below the chamber. The Furnace 22 receives fuel through a Fuel Line 28 that travels through a Fuel Control Valve 24a. In the preferred embodiment, the Furnace 22 burns hydrogen as a fuel source due to the non-polluting nature of hydrogen. Other fuel sources for the Furnace 22 includes natural gas, propane, butane, ethane, or atomized or vaporized gasoline. The Fuel Control Valve 24a is controlled by a Control Module 50, where the Control Module 50 includes a processor and applicable input and output mechanisms capable of controlling the engine and attached or interactive components. The fuel supply is controlled to maintain a preset constant pressure in the system. The Chamber 20 further includes a Pressure Relief Valve 24b. In the preferred embodiment, the Pressure Chamber 20 includes fire tubing as shown with Fire Tubes 25. The heat from the Furnace 22 increases the air pressure volume within the Pressure Chamber 20 and releases expanding Air Pressure 27 through an Air Pressure Input Pipe 29 leading to a Manual Pressure Control Valve 31. The fire tubing may include stainless steel inserts impregnated with platinum; rhodium and palladium found in our modern exhaust systems insuring a more complete combustion of any fuel used. Exhaust from the Furnace 22 exits through the Fire

Tubes 25.

An Air Pressure Input Tube 32 leads from a One-Way Check Valve 33a into the Pressure Chamber 20 from a Buffer Chamber 40 as depicted in FIG. 2. The Buffer Chamber 40 includes a Pressure Sensor 44 that is connected to a Control Module 50. The pressure in the Buffer Chamber 40 is controlled by the Pressure Sensor 44. Further a Pressure Release Valve 42 is provided on the top of the Buffer Chamber 40. The buffer chamber also has a second One-Way Check Valve 33b on the opposite side of the Check Valve 33a. The air input pipe extends further into a Back Pressure Check Valve 86 leading from a Compressor 80.

Other components integrated into the system according to the present invention includes a Rotary Housing 60 as depicted in FIG. 4. The Rotary Housing 60 includes a Drive Shaft 63 and a Rotor 61. The Rotor 61 rotates clockwise and includes a Rotor Vane 64 and a chamber divider valve 65. A computer controlled Pressure Sensor 69 is also provided on the surface of the Housing 60 that sends control signals back to the Control Module 50. Expanding pressure 71 drives the rotation of the Rotor 61. Leading into the Housing 60 is air pressure to Rotor Vane 64. This air pressure travels through the Solenoid Pressure Control Valve 34 and the Manual Pressure Control Valve 31 from the Pressure Chamber 20. An Exhaust 76 is also provided for the Rotary Housing 60 where the Exhaust 76 extends through a Housing Cover 73.

The Housing Cover 73 covers a Control Assembly Housing 70. The Compressor 80 includes Rotary Compressor Vanes 81a, 81b and a Drive Shaft 84, which drives a Compressor Rotor 83. Although labeled as two elements, in the embodiment, Drive Shaft 63 and Drive Shaft 84 in fact comprise a single drive shaft shared by the compressor 73 and Rotary Housing 60. As shown, the pressure from the Compressor 80 is released through a one-way Check Valve 33b to Buffer Chamber 40. Further components of the Compressor 80 include the Pressure to Chamber 87 and Pressure Valve 85. Air 82 circulating in the Compressor 80 is released, in part, to the Pressure Chamber 87, which keeps Pressure Valve 85 in operational position. Air intake 89 is also shown which provides air intake into the Compressor 80. The Control Assembly Housing 70 provides a control mechanism for both the Compressor 80 and Rotary Housing 60.

The present invention provides a compressed air-pressure driven engine derived from expanded compressed air as opposed to using a hydrocarbon source. Use of this rotary engine is therefore capable of eliminating hydrocarbon reciprocating engines and reducing dependence on hydrocarbon fuels. The instant invention has been shown and described in what it considers to be the most practical and preferred embodiments. It is recognized, however, that departures may be made from within the scope of the invention and that obvious modifications may occur to a person skilled in the art.

What is claimed is:

1. A rotary engine system powered by pressurized air comprising:
a. a pressure chamber, where pressure chamber includes a furnace beneath the pressure chamber;
b. a rotary engine, where the rotary engine receives pressurized air from the pressure chamber;
c. a rotary compressor, where the rotary engine and rotary compressor share a drive shaft, the rotary compressor creates compressed air that is transmitted to the pressure chamber;
d. a buffer chamber, where the buffer chamber receives the compressed air prior to transfer into the pressure chamber; and
e. a control module, where the control module controls functions related to the rotary engine, pressure chamber, buffer chamber and fuel control.

2. The rotary engine system according to claim 1, where the rotary engine includes a rotary vane that receives the pressurized air.

3. The rotary engine system according to claim 1, where the pressure chamber includes fire tubing and the fire tubing provides a means to exhaust spent fuel from the furnace.

4. The rotary engine system according to claim 1, further including a first check valve between the rotary compressor and the buffer chamber and a second check valve between the buffer chamber and the pressure chamber.

5. The rotary engine system according to claim 1, further including a manual pressure control valve and a solenoid pressure control valve between the pressure chamber and rotary engine.

6. The rotary engine system according to claim 1, where the compressor includes two rotary compressor vanes.

7. The rotary engine system according to claim 1, where the compressor includes pressure to the pressure maintaining its operational position.

8. The rotary engine system according to claim 1, where the control connects to a buffer sensor on the buffer chamber, a fuel control valve, a solenoid pressure control valve between the pressure chamber and rotary engine, and a pressure control sensor on the rotary engine.

9. The rotary engine system according to claim 1, where the compressor includes a compressor rotor.
